(19) United States
(12) Patent Application Publication
(10) Pub. No.: US 2013/0144752 A1
(43) Pub. Date: Jun. 6, 2013

(54) RECOMMENDATION ASSIST DEVICE, RECOMMENDATION ASSIST SYSTEM, USER DEVICE, RECOMMENDATION ASSIST METHOD AND PROGRAM STORAGE MEDIUM

(71) Applicant: Masakazu Moriguchi, Tokyo (JP)

(72) Inventor: Masakazu Moriguchi, Tokyo (JP)

(73) Assignee: NEC CORPORATION

(21) Appl. No.: 13/817,373

(22) PCT Filed: Aug. 16, 2011
(86) PCT No.: PCT/JP2011/068821

§ 371 Date: Feb. 15, 2013

(30) Foreign Application Priority Data
Aug. 23, 2010 (JP) 2010-185969

(51) Int. Cl. G06Q 30/06

(52) U.S. Cl. CPC G06Q 30/0631
USPC 705/26.7

(57) ABSTRACT

Provided are a recommendation assist device and the like which enable recommendation of contents suitable for a user.

The recommendation assist device includes an appreciation degree acquisition means (an appreciation degree acquisition unit) and an algorithm determination means (an algorithm determination unit). The appreciation degree acquisition means acquires a user's appreciation degree on an algorithm which is one of a plurality of algorithms each for calculating recommendation orders of respective contents, and which has calculated recommendation orders of the respective contents having been produced to the user. The algorithm determination means calculates aptitude degrees of the respective plurality of algorithms based on the acquired appreciation degree.

### TECHNICAL FIELD

The present invention relates to a recommendation assist device, a recommendation assist system, a user device, a recommendation assist method and a program storage medium.

### BACKGROUND ART

In recently yeas, there have been increasing users who utilize online shopping services. This online shopping service is a service for selling goods by mail order via the Internet. In a shopping site providing the online shopping service, a wide variety of goods are dealt with. Users can purchase their desired goods by selecting them from among these wide variety of goods.

Since a wide variety of goods are dealt with at the shopping site, when a user utilizes the online shopping service, the user sometimes cannot decide which one of the goods the user should purchase. For this reason, among such shopping sites, there has been increasing such a site that provides users with a service described below. This service is a service for producing, to a user, goods which are expected to match in preference of the user (hereinafter, this service will be also referred to as a recommendation service). In this recommendation service, for example, a collaborative filtering is used. This collaborative filtering is one of algorithms (recommendation algorithms). The collaborative filtering (algorithm) accumulates information in relation to preference of a lot of users. Further, by using information in relation to other users (customers) having preference similar to that of a user (a customer) which is provided with a recommendation service, the collaborative filtering infers goods which are expected to fit in preference of the user (the customer).

Recommendation algorithms currently utilized in the recommendation service include, besides the collaborative filtering, various recommendation algorithms. These recommendation algorithms have their own unique features. For example, the above-described the collaborative filtering employs an algorithm which calculates a predicted aptitude value based on other users' appreciations. As described above, in the collaborative filtering, an appreciation is performed based on other users' appreciations. Consequently, the collaborative filtering has an advantage in that it is possible to obtain a recommendation result which is unpredictable for a user.

In contrast, the collaborative filtering has a disadvantage in that it is difficult to recommend goods having no appreciation provided by other users. Further, fundamentally, preference is different for each user. Thus, users having major preference can effectively utilize recommendation results brought by the collaborative filtering (i.e., recommendation results based on information in relation to other users). There is also a disadvantage, however, in that users having non-major preference cannot effectively use such recommendation results.

For example, Patent Literature 1 (PTL 1) (Japanese Patent Application Unexamined Publication No. 2008-244602) discloses a display device which displays information for recommending broadcast programs. This display device prepares a plurality of user profiles in order to recommend further useful viewing information for users. Further, the display device changes recommendation results based on the user profiles and the preference characteristics of program selections.

Patent Literature 2 (PTL 2) (Japanese Patent Application Unexamined Publication No. 2009-252178) discloses a recommendation information evaluation device. This recommendation information evaluation device corrects characteristic vectors of contents having been selected and characteristic vectors of contents having not been selected. Further, the recommendation information evaluation device generates user characteristic vectors for each recommendation content category by using the corrected content characteristic vectors. The recommendation information evaluation device evaluates contents based on user characteristic vectors corresponding to the respective recommendation content categories.

Patent Literature 3 (PTL 3) (Japanese Patent Application Unexamined Publication No. 2008-117014) discloses an information delivery system. This information delivery system receives importance degree setting information transmitted from a user terminal. Further, the information delivery system calculates a second aptitude value of a statistics target for each information category by using a first aptitude value and the importance degree setting information. Moreover, the information delivery system extracts a statistics target suitable for a user by using the calculated second aptitude value.

Patent Literature 4 (PTL 4) (Japanese Patent Application Unexamined Publication No. 2002-123547) discloses a goods selection assist system which makes it possible to easily select a goods item equipped with desired functions from among a set of goods.

Patent Literature 5 (PTL 5) (Japanese Patent Application Unexamined Publication No. 2009-289092) discloses an information processing device which makes it possible to flexibly combine various algorithms when recommending contents.

### CITATION LIST

### Patent Literature

PTL 1: Japanese Patent Application Unexamined Publication No. 2008-244602
PTL 2: Japanese Patent Application Unexamined Publication No. 2009-252178
PTL 3: Japanese Patent Application Unexamined Publication No. 2008-117014
PTL 4: Japanese Patent Application Unexamined Publication No. 2002-123547
PTL 5: Japanese Patent Application Unexamined Publication No. 2009-289092

### SUMMARY OF INVENTION

### Technical Problem

The device disclosed in the Patent Literature 1 acquires a user's preference characteristic in advance from a plurality of user profiles. Thus, the device can recommend the user's favorite programs based on the contents of programs which are registered in the user profiles in advance. However, the device does not take into consideration the user's appreciation (i.e., the user's appreciation from the viewpoint of, for example, a satisfaction degree, unpredictability and the like) on the recommendation result. Consequently, the device is not necessarily capable of producing an optimal recommendation result for a user.

Further, the device disclosed in the Patent Literature 2 calculates a recommendation result based on appreciations in relation to closely-associated categories. However, the device does not take into consideration a user's appreciation on the recommendation result, just like in the case of the Patent Literature 1. Consequently, the device is not necessarily capable of providing an optimal recommendation result for a user.

Further, the system disclosed in the Patent Literature 3 generates recommendation information for a user by using two appreciation values. These two appreciation values are values having been calculated in advance, and do not reflect a user's appreciation on a recommendation result. Consequently, the system is not necessarily capable of producing an optimal recommendation result for a user.

Further, each of the system and the device disclosed in the Patent Literatures 4 and 5 calculates a recommendation result based on appreciation values having been registered in advance. The appreciation values do not reflect a user's appreciation on the recommendation result. Consequently, the system and the device disclosed in the Patent Literatures 4 and 5 are not necessarily capable of producing a user with an optimal recommendation result, just like in the case of the Patent Literature 3.

The present invention has been invented in order to solve the above-described problems. That is, a main object of the present invention is to provide a recommendation assist device, a recommendation assist system, a user device, a recommendation assist method and a program storage medium which enable recommendation of contents matching in a user's preference to a greater degree.

### Solution to Problem

A recommendation assist device according to an aspect of the present invention includes: appreciation degree acquisition means for acquiring a user's appreciation degree on a certain algorithm which is one of a plurality of algorithms each for calculating recommendation orders of respective contents, and which has calculated recommendation orders of the respective contents having been provided to the user; and

algorithm determination means for calculating aptitude degrees of the respective plurality of algorithms based on the acquired appreciation degree.

A user device according to another aspect of the present invention includes a configuration that receives a user's appreciation degree on recommendation orders of respective contents having been provided by the recommendation assist device according an aspect of the invention; and transmits the received appreciation degree to the recommendation assist device.

A recommendation assist device according to another aspect of the present invention includes: the recommendation assist device according to an aspect of the present invention, and the user device according to another aspect of the present invention.

A recommendation assist method according to another aspect of the present invention includes: acquiring a user's appreciation degree on a certain algorithm which is one of a plurality of algorithms each for calculating recommendation orders of respective contents, and which has calculated recommendation orders of the respective contents having been provided to the user; and calculating aptitude degrees of the respective plurality of algorithms based on the acquired appreciation degree.

A program storage medium according to another aspect of the present invention stores therein a program causing a computer to execute processing including: a process of, for the respective plurality of algorithms, calculating importance degrees of a certain content having been selected by the user, and a process of calculating aptitude degrees of the respective plurality of algorithms based on the acquired appreciation degree.

### Advantageous Effects of Invention

According to the present invention, it is possible to recommend contents which match in users' preference to a greater degree.

### BRIEF DESCRIPTION OF DRAWINGS

FIG. 1 is block diagram illustrating a configuration of a recommendation assist system according to a first exemplary embodiment of the present invention.

FIG. 2 is a diagram illustrating a hardware configuration of an algorithm determination device and a user device which constitute a recommendation assist system according to a first exemplary embodiment of the present invention.

FIG. 3 is a diagram illustrating an example of information stored in an algorithm storage unit constituting a recommendation assist system according to a first exemplary embodiment of the present invention.

FIG. 4 is a diagram illustrating an example of information stored in an aptitude value storage unit constituting a recommendation assist system according to a first exemplary embodiment of the present invention.

FIG. 5 is flowchart illustrating an example of operation of a recommendation assist system according to a first exemplary embodiment of the present invention.

FIG. 6 is a diagram illustrating an example of recommendation orders of respective contents, having been calculated by each of recommendation algorithms stored in an algorithm storage unit.

FIG. 7 is a diagram illustrating an example of a content list having been recommended by an optimal algorithm stored in an algorithm storage unit.

FIG. 8 is a diagram illustrating an example of an input interface for an appreciation degree, included in an appreciation degree acquisition unit constituting a recommendation assist system according to a first exemplary embodiment of the present invention is composed.

FIG. 9 is a diagram illustrating an example of an appreciation degree stored in an appreciation degree storage unit.

FIG. 10 is a diagram illustrating an example of each importance degree of a content, having been calculated by an importance degree calculation unit constituting a recommendation assist system according to a first exemplary embodiment of the present invention is composed.

FIG. 11 is a diagram illustrating an example of an aptitude value having been calculated by an algorithm determination unit constituting a recommendation assist system according to a first exemplary embodiment of the present invention is composed.

FIG. 12 is a diagram illustrating an example of aptitude values of respective algorithms, having been calculated by an algorithm determination unit.

FIG. 13 is a diagram illustrating another example of an appreciation degree acquired by an appreciation degree acquisition unit constituting a recommendation assist system according to a first exemplary embodiment of the present invention.

FIG. 14 is block diagram illustrating a configuration of a recommendation assist system according to a second exemplary embodiment of the present invention.

### DESCRIPTION OF EMBODIMENTS

Hereinafter, exemplary embodiments according to the present invention will be described with reference to the drawings.

### First Exemplary Embodiment

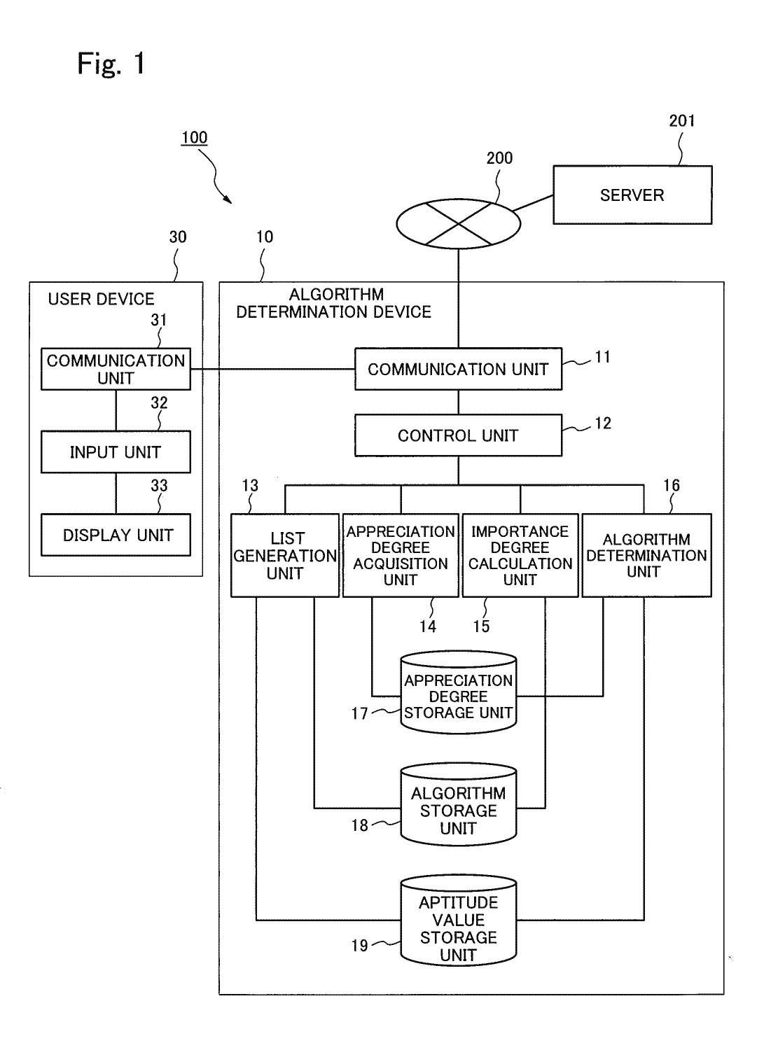

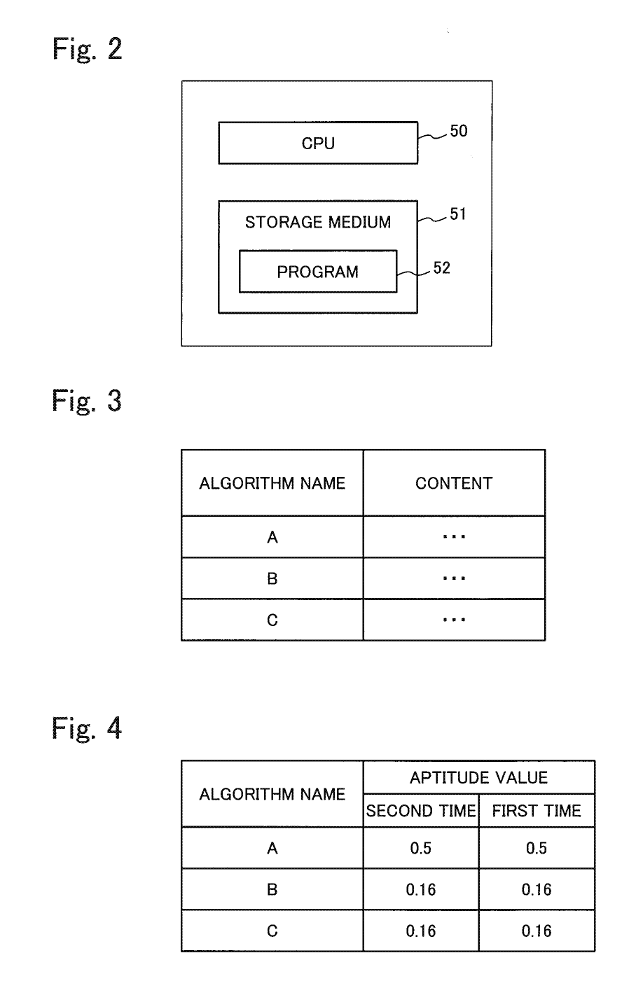

FIG. 1 is a block diagram illustrating a configuration of a recommendation assist system 100 according to a first exemplary embodiment of the present invention. As shown in FIG. 1, the recommendation assist system 100 includes an algorithm determination device 10 and a user device 30. The User device 30 includes a communication unit 31, an input unit 32 and a display unit 33. The algorithm determination device 10 includes a communication unit 11, a control unit 12, a list creation unit 13, an appreciation degree acquisition unit (an appreciation degree acquisition means) 14, an importance degree calculation unit (an importance degree calculation means) 15, an algorithm determination unit (an algorithm determination means) 16, an appreciation degree storage unit 17, an algorithm storage unit 18 and an aptitude value storage unit 19. The algorithm determination device 10 and the user device 30 each have a hardware configuration shown in FIG. 2 in the case where they are each realized by a computer. The configuration shown in FIG. 2 includes a central processing unit (CPU) 50, a storage medium (for example, random access memory (RAM), read only memory (ROM) and a hard disk storage device) 51 and a program (a software program; a computer program) 52. The CPU 50 for each of the devices 10 and 30 controls the entire operation for each of the devices 10 and 30 by executing various programs. In other words, the CPU 50 accesses programs and data stored in the storage medium 51 appropriately, and thereby, realizes individual functions (individual units), shown below, included in each of the algorithm determination device 10 and the user device 30.

More specifically, the CPU 50 accesses the storage medium 51 appropriately, and thereby, executes programs which realize the functions of the communication unit 11, the control unit 12 and the like included in the algorithm determination device 10. Further, the CPU 50 accessing the storage medium 51 appropriately, and thereby, executes programs which realize the functions of the communication unit 31 and the like included in the user device 30.

First, the outline of the user device 30 will be described.

The user device 30 is a device which is operated by a user. The user can browses contents and the like over the Internet by operating the user device 30.

The user device 30 is, for example, a personal computer. The user device 30 is equipped with an operating system (OS) which provides a graphical user interface (GUI) environment. As described above, the user device 30 includes the communication unit 31, the input unit 32 and the display unit 33.

The communication unit 31 has the function of communicating with the communication unit 11 of the algorithm determination device 10. The input unit 32 has the function of receiving inputs by a user. The input unit 32 is, for example, an operation unit of a personal computer. The Display unit 33 has the function of displaying information related to contents and the like toward users. More specifically, the display unit 33 is, for example, a display of a personal computer, a television (TV) device and a terminal device (for example, a printer). In addition, the user device 30 is not limited to a personal computer, and besides, may be a mobile telephone, a smart phone and a personal digital assistant (PDA) or the like.

Next, the outline of the algorithm determination device 10 will be described.

As described above, the algorithm determination device 10 includes the communication unit 11, the control unit 12, the list creation unit 13, the appreciation degree acquisition unit 14, the importance degree calculation unit 15, the algorithm determination unit 16, the appreciation degree storage unit 17, the algorithm storage unit 18 and the aptitude value storage unit 19.

The communication unit 11 has the function of communicating with the Internet 200 and the communication unit 31 of the user device 30. The control unit 12 has the function of controlling individual units of the algorithm determination device 10. The list creation unit 13 has the function of creating content lists based on recommendation algorithms stored in the algorithm storage unit 18. The content list is a list for displaying contents acquired from the Internet 200 via the communication unit 11. The appreciation degree acquisition unit 14 has the function of acquiring a user's appreciation degree on recommendation orders of contents, which have been determined by the algorithm determination device 10. The appreciation degree is a value which indicates the degree of a user's appreciation, that is, a user's degree of feelings, such as a satisfaction degree and a favorable-impression degree, on recommendation orders of contents displayed on the display unit 30 of the user device 30.

The importance degree calculation unit 15 has the function of, for a content having been selected by a user via the input unit 32, calculating importance degrees for a content list having been generated by the list creation unit 13 (detailed description will be made hereinafter). The algorithm determination unit 16 has the function of calculating an aptitude value (an aptitude degree) of each recommendation algorithms based on an appreciation degree having been inputted by a user via the input unit 32 and importance degrees having been calculated by the importance degree calculation unit 15 (detailed description will be made hereinafter). The aptitude value is a value which indicates how much degree a recommendation algorithm is suitable for a user.

The appreciation degree storage unit 17 stores therein a user's appreciation degree on a recommendation algorithm, having been acquired by the appreciation degree acquisition unit 14 (detailed description will be made hereinafter). The algorithm storage unit 18 stores therein recommendation algorithms each for determining recommendation orders of a respective plurality of contents. FIG. 3 is a diagram illustrating an example of information stored in the algorithm storage unit 18. As shown in FIG. 3, the algorithm storage unit 18 stores therein the names of recommendation algorithms and the contents thereof such that the contents thereof are correlated with the corresponding names thereof. In an example shown in FIG. 3, names such as an algorithm A, an algorithm 13 and an algorithm C and the corresponding contents thereof are stored.

The aptitude value storage unit 19 stores therein the recommendation algorithms stored in the algorithm storage unit 18 and the histories of aptitude values having been calculated by the algorithm determination unit 16 such that histories thereof are correlated with the corresponding recommendation algorithms. FIG. 4 is a diagram illustrating an example of information stored in the aptitude value storage unit 19. As shown in FIG. 4, the aptitude value storage unit 19 stores therein the histories of aptitude values having been calculated in the past for the corresponding recommendation algorithms (detailed description will be made hereinafter).

Specifically, the appreciation degree storage unit 17, the algorithm storage unit 18 and the aptitude value storage unit 19 are each realized by a storage device, such as a memory module or a hard disk device. In this case, the storage device included in the algorithm determination device 10 functions as the appreciation degree storage unit 17, the algorithm storage unit 18 and the aptitude value storage unit 19.

The algorithm determination device 10 and the user device 30 may be separated into mutually different devices, or may be integrated into the same device. Further, the algorithm determination device 10 may not include the appreciation degree storage unit 17, the algorithm storage unit 18 and the aptitude value storage unit 19. In this case, the algorithm determination device 10 causes an external storage device to have the functions as the appreciation degree storage unit 17, the algorithm storage unit 18 and the aptitude value storage unit 19. The algorithm determination device 10 may be configured such that it stores information related to the recommendation algorithms into the external storage device, and it reads out the information from the external storage device.

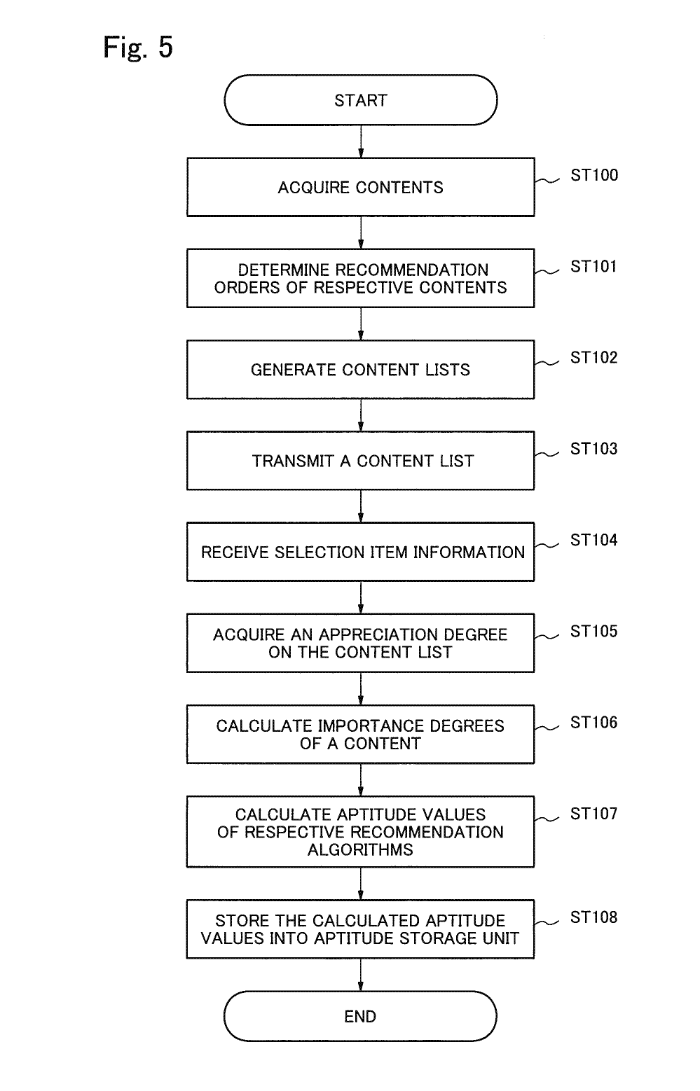

FIG. 5 is a flowchart illustrating an example of operation of the recommendation assist system 100. The operation of the recommendation assist system 100 will be described with reference to FIG. 5.

When browsing a content to be exhibited via the Internet 200, a user inputs a command for instructing browsing of the content on the input unit 32 of the user device 30. For example, when wanting to browse news, the user selects a list of news from a portal site. When wanting to shop, the user selects a category of goods from a shopping site.

When the user has selected a content by using the input unit 32, the communication unit 31 of the user device 30 transmits information indicating the selected content to the algorithm determination device 10. Further, in response to the selection, the algorithm determination device 10 acquires contents corresponding to the selection from the server 201 or the like connected to the Internet 200, via the communication unit 11 (step ST100).

At this time, it is supposed that the algorithm determination device 10 acquires a plurality of contents corresponding to the selection. The algorithm determination device 10 determines recommendation orders of the respective plurality of acquired contents in accordance with the following operation.

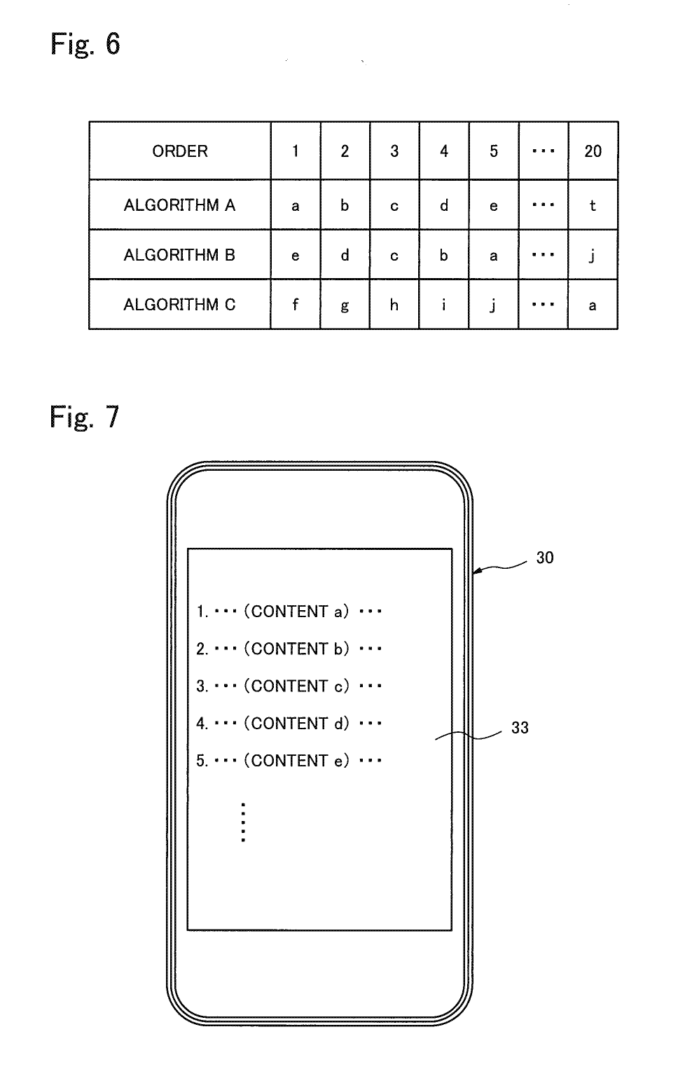

The communication unit 11 of the algorithm determination device 10 notifies the list creation unit 13 of the plurality of acquired contents via the control unit 12. The list creation unit 13 allows each of recommendation algorithms to determine recommendation orders of the respective plurality of acquired contents (step ST101). Specifically, the list creation unit 13 allows each of recommendation algorithms (for example, the algorithm A, the algorithm B and the algorithm C shown in FIG. 3) stored in the algorithm storage unit 18 to calculate recommendation orders of the respective acquired contents. FIG. 6 is a diagram illustrating an example of recommendation orders of respective contents, having been calculated by each of the recommendation algorithms. In this example, the number of contents having been acquired via the Internet 200 is 20. The names of these contents are a content “a”, a content “b”, a content “c” . . . . The list creation unit 13 allows each of the recommendation algorithms to determine recommendation orders of the respective contents. That is, for each of the recommendation algorithms, the list creation unit 13 sequentially assigns a recommendation order in descending order of priority to a content having the highest one to a content having the lowest one of importance degrees having been calculated by each of the recommendation algorithms. In the example shown in FIG. 6, a content having been calculated by the algorithm A as first is the content “a”. A content having been calculated by the algorithm B as second is the content “d”. A content having been calculated by the algorithm C as twentieth is the content “a”.

Next, the list creation unit 13 generates content lists (step ST102). These content lists are lists in which the contents, for which corresponding recommendation orders have been calculated, are arranged in order in accordance with their recommendation orders, for each of the recommendation algorithms. In the following description, the content lists based on the algorithms A, B and C will be referred to as content lists A, B and C, respectively.

Subsequently, the list creation unit 13 transmits a content list to the user device 30 (step ST103). The transmitted content list is a content list based on a recommendation algorithm which has been selected in such a way as described below from among the recommendation algorithms stored in the algorithm storage unit 18.

Specifically, the list creation unit 13 reads out the name of a recommendation algorithm, which has the highest aptitude value of those having been calculated last time, from the aptitude value storage unit 19 as the name of an optimal algorithm. For example, in the case where information shown in FIG. 4 is stored in the aptitude value storage unit 19, a recommendation algorithm having the highest aptitude value of those having been calculated last time is the algorithm A. In this case, the list creation unit 13 transmits the content list A based on the algorithm A to the user device 30. As a result, the user device 30 displays the content list A on the display unit 33. FIG. 7 is a diagram illustrating an example of a content list in which contents are arranged in order in accordance with their recommendation orders having been determined by an optimal algorithm.

Here, it is supposed that, from the content list having been displayed in this way, a user has selected a content with interest by using the input unit 32. For example, it is supposed that the user has selected the content “a”. The user device 30 transmits information indicating the selected content “a” (hereinafter, referred to as selected item information) to the algorithm determination device 10 via the communication unit 31.

The control unit 12 of the algorithm determination device 10 receives the selected item information via the communication unit 11 (step ST104). The control unit 12 of the algorithm determination device 10 notifies the appreciation degree acquisition unit 14 and the importance degree calculation unit 15 of the selection of the content “a” based on the selected item information.

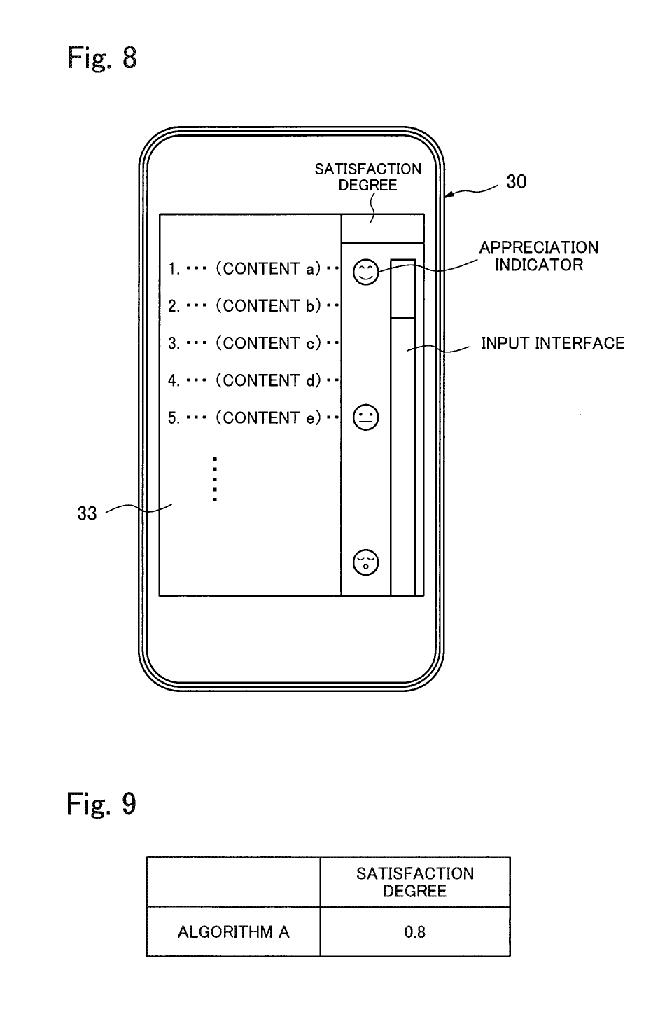

Upon reception of the notification, the appreciation degree acquisition unit 14 acquires the user's appreciation degree on the content list (the content list A) displayed on the display unit 33 of the user device 30 in such a way as follows (step ST105). For example, the appreciation degree acquisition unit 14 displays an input-interface image for inputting an appreciation degree, on the display unit 33 of the user device 30. FIG. 8 is a diagram illustrating an example of an input interface for inputting an appreciation degree. In the example shown in FIG. 8, an input-interface image is an image representing a bar graph. On the display unit 33, icons each indicating an appreciation indicator are displayed together with the input-interface image. In the example shown in FIG. 8, the appreciation degree acquisition unit 14 allows a user to input an appreciation degree, such as a “satisfaction degree”, as an appreciation item. The user inputs the satisfactory degree on the recommendation orders of the respective contents displayed on the display unit 33 by operating the bar graph by means of the input unit 32. Upon input of the appreciation degree (satisfaction degree), the user device 30 transmits information (value) indicating the inputted appreciation degree (satisfaction degree) to the algorithm determination device 10 via the communication unit 31. For example, the user device 30 transmits information (value) indicating which position on the bar graph is selected to the algorithm determination device 10.

When having received the information via the communication unit 11, the appreciation degree acquisition unit 14 of the algorithm determination device 10 calculates an appreciation degree based on the information and appreciation-degree operation data (for example, relation data between positions on the bar graph functioning as the input interface and appreciation degrees). Further, the appreciation degree acquisition unit 14 stores therein the calculation result into the appreciation degree storage unit 17. FIG. 9 is a diagram illustrating an example of an appreciation degree stored in the appreciation degree storage unit 17. In the example shown in FIG. 9, for example, information indicating that the “appreciation degree (satisfaction degree)” on the algorithm A is “0.8” is stored in the appreciation degree storage unit 17.

Further, the appreciation degree acquisition unit 14 notifies the algorithm determination unit 16 of the information related to the calculated appreciation degree.

Next, the importance degree calculation unit 15 calculates an importance degree of the content having been selected by the user (in this example, the content “a”), for each of the recommendation algorithms (step ST106). For example, the importance degree calculation unit 15 calculates the importance degree for each of the recommendation algorithms as follows.

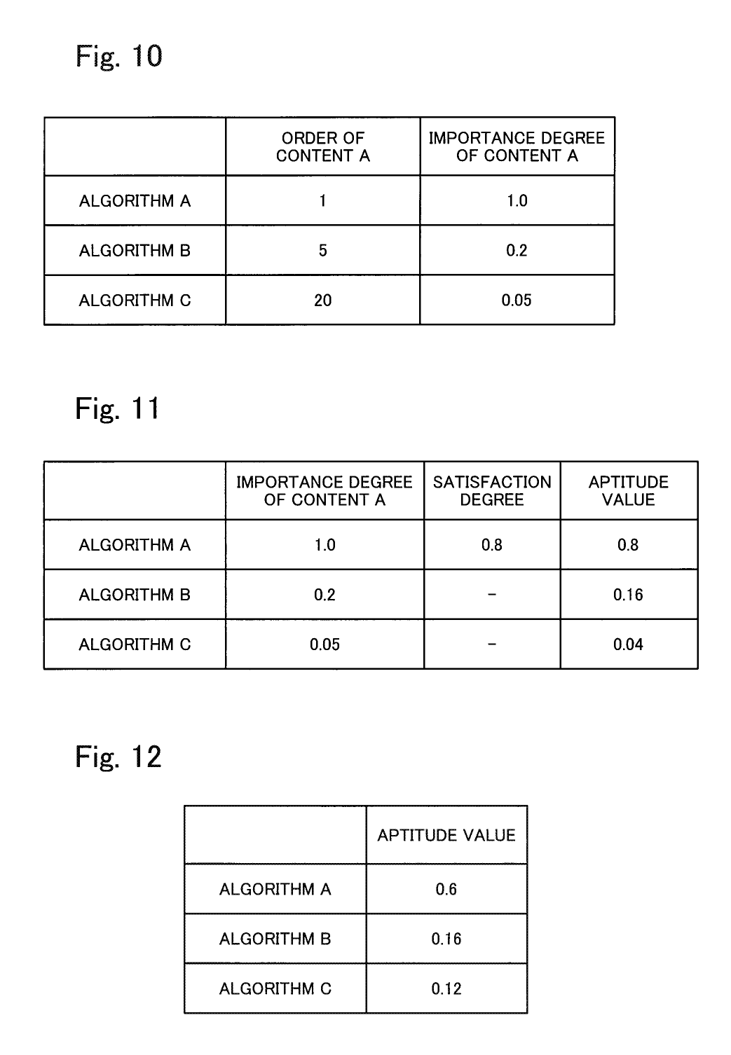

The importance degree calculation unit 15 calculates, for each of the recommendation algorithms, an importance degree of the content “a” having been selected by the user, based on the recommendation orders having been calculated by the list creation unit 13 in step ST101. For example, the importance degree calculation unit 15 calculates the “reciprocal” of a recommendation order as an “importance degree of a content”. Specifically, in the example shown in FIG. 6, the recommendation orders of for the content “a” according to the algorithms A, B and C stored in the algorithm storage unit 18 are first, fifth and twentieth, respectively. In the case where a recommendation order of the content “a” according to the algorithm A indicates “1”, the importance degree calculation unit 15 regards the reciprocal thereof, that is, “1.0”, as the importance degree of the content “a” according to the algorithm A. Further, in the case where a recommendation order of the content “a” according to the algorithm B indicates “5”, the importance degree calculation unit 15 regards the reciprocal thereof, that is, “0.2”, as the importance degree of the content “a” according to the algorithm B. Similarly, in the case where a recommendation order of the content “a” according to the algorithm C indicates “20”, the importance degree calculation unit 15 regards the reciprocal thereof, that is, “0.05”, as the importance degree of the content “a” according to the algorithm C. FIG. 10 is a diagram illustrating an example of respective importance degrees of the content “a” according to the algorithms A, B and C.

The importance degree calculation unit 15 notifies the algorithm determination unit 16 of information related to the calculated importance degrees. The algorithm determination unit 16 calculates aptitude values of the respective recommendation algorithms based on the received importance degrees and the appreciation degree having been acquired from the appreciation degree acquisition unit 14 (refer to step ST105) (step ST107).

For example, first, the algorithm determination unit 16 calculates the aptitude value of the algorithm A based on the importance degree of the content “a” according to the algorithm A and the user's satisfaction degree 0.8. FIG. 11 is a diagram illustrating an example of aptitude values having been calculated by the algorithm determination unit 16, together with importance degrees and satisfaction degrees. In the example shown in FIG. 11, the algorithm determination units 16 determines the satisfaction degree as the aptitude value of the algorithm A just as it is. That is, for the algorithm A, the importance degree of the content “a” is 1.0. Further, for the algorithm A, the user's satisfaction degree is 0.8. The algorithm determination unit 16 determines the satisfaction degree “0.8” as the aptitude value of the algorithm A just as it is.

In the example shown in FIG. 11, although there exists information related to a user's satisfaction degree for the algorithm A, there exists no information related to a user's satisfaction degree for each of the algorithms B and C. That is, the algorithm A is an algorithm which has been used for the content list having been displayed on the display unit 33 of the user device 30. Accordingly, information related to a user's appreciation degree (satisfaction degree) on this algorithm A is inputted by the user. In contrast, for the other algorithms B and C, the user does not appreciate them (the user cannot appreciate them). As a result, there is no information related to a user's appreciation degree (satisfaction degree) on each of the algorithms B and C. For this reason, the algorithm determination unit 16 may prediction aptitude values of the respective algorithms B and C based on the aptitude value of the algorithm A. For example, the aptitude values may be calculated (predicted) such that, for the content “a”, the ratios of aptitude values relative to importance degrees according to the respective recommendation algorithms are equal to one another. That is, in the example shown in FIG. 11, for the content “a”, the ratio of the aptitude value relative to the importance degree according to the algorithm A is 0.8 to 1.0. The algorithm determination unit 16 calculates an aptitude value of the content “a” according to the algorithm B so that the ratio of the aptitude value relative to the importance degree according to the algorithm B is also equal thereto. That is, the algorithm determination unit 16 calculates an aptitude value of the algorithm B as follows: (0.8×0.2÷1.0=0.16). Similarly, the algorithm determination unit 16 calculates an aptitude value of the algorithm C, and its result is 0.04.

The algorithm determination unit 16 may also calculate the aptitude values of the respective recommendation algorithms by using the histories of the aptitude values stored in the aptitude value storage unit 19 (refer to FIG. 4), in addition to the calculated values (the aptitude values) having been calculated in such a way as described above. For example, the algorithm determination unit 16 may calculate an average value of aptitude values for the previous predetermined number of times (for example, two times) and the calculated value (the aptitude value), shown in FIG. 11, having been calculated this time in such a way as described above, and may determine the calculated average value as this time target aptitude value of a certain one of the recommendation algorithms. FIG. 12 is a diagram illustrating an example of an aptitude value for each of the recommendation algorithms, resulting from calculation including the history of aptitude values. That is, in the example shown in FIG. 12, the algorithm determination unit 16 calculates, for the content “a”, an average value of a first time aptitude value of the algorithm A (refer to FIG. 4), i.e., 0.5, a second time aptitude value thereof, i.e., 0.5 and this time calculated value (an aptitude value thereof; refer to FIG. 11), i.e., 0.8, and determines the calculated average value, i.e., 0.6 as a target aptitude value. Similarly, the algorithm determination unit 16 calculates, for the content “a”, an average value of a first time aptitude value of the algorithm B (refer to FIG. 4), i.e., 0.16 and a second time aptitude value thereof, i.e., 0.16 and this time calculated value (an aptitude value thereof; refer to FIG. 11), i.e., 0.16, and determines the calculated average value, i.e., 0.16 as a target aptitude value. Further, similarly, the algorithm determination unit 16 calculates, for the content “a”, an average value of a first time aptitude value of the algorithm C (refer to FIG. 4), i.e., 0.16 and a second time aptitude value thereof, i.e., 0.16 and this time calculated value (an aptitude value thereof; refer to FIG. 11), i.e., 0.04, and determines the calculated average value, i.e., 0.12 as a target aptitude value.

The algorithm determination unit 16 stores the aptitude values of the respective recommendation algorithms, having been calculated in such a way as described above, into the aptitude value storage unit 19 (step ST108).

As described above, a recommendation algorithm which has the highest one of the aptitude values having been calculated by the algorithm determination unit 16 becomes an optimal algorithm for the user. When the algorithm determination device 10 transmits a content list to the user device 30 next, the algorithm determination device 10 transmits a content list including recommendation orders having been calculated by the optimal algorithm to the user device 30 (refer to step ST103).

In addition, in the example described above, the appreciation degree acquisition unit 14 acquires a “satisfaction degree” as an appreciation degree. In addition thereto, the appreciation degree acquisition unit 14 may also acquire the appreciation degrees other than the “satisfaction degree”, among appreciation items.

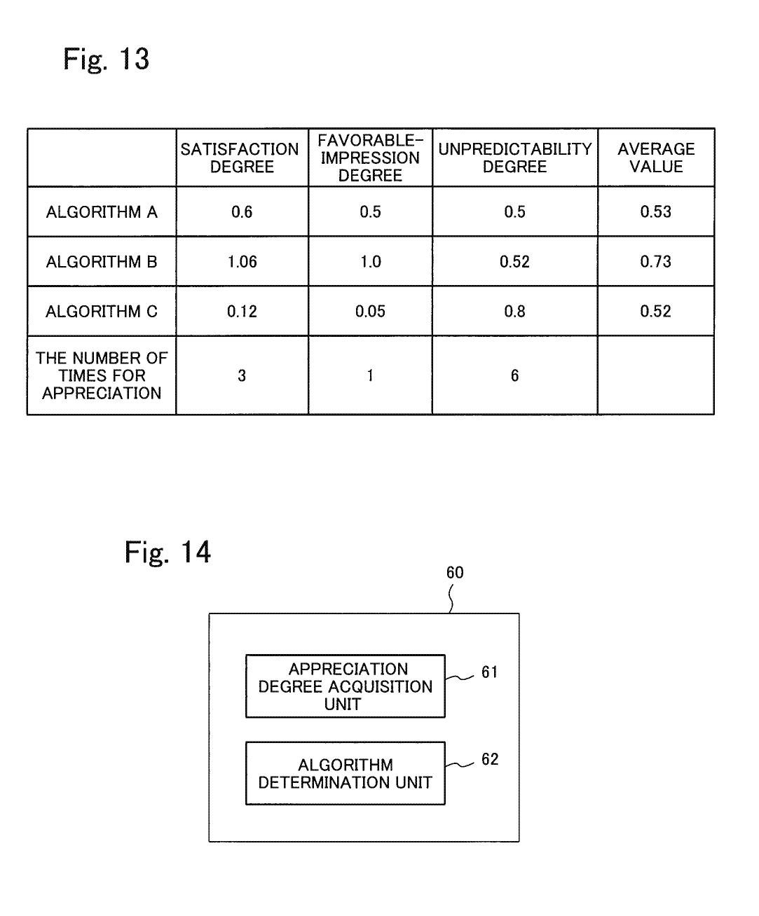

FIG. 13 is a diagram illustrating another example of appreciation degrees of appreciation items, acquired by the appreciation degree acquisition unit 14. In the example shown in FIG. 13, as the appreciation degrees, a favorable-impression degree and an unpredictability degree are taken in addition to the satisfaction degree. Further, in the example shown in FIG. 13, the appreciation degree acquisition unit 14 has acquired the satisfaction degree, the favorable-impression degree and the unpredictability degree six times, once and six times, respectively. For example, it is supposed that a user desires to select a recommendation algorithm having high values in all the appreciation degrees, and has performed a setting for this. In this case, the appreciation degree acquisition unit 14 calculates an average value of the previous values for each of the appreciation degrees. Moreover, the appreciation degree acquisition unit 14 may regard an average value thereof as an appreciation degree for each of the recommendation algorithms. In this case, in the example shown in FIG. 13, the algorithm B is a recommendation algorithm having the highest aptitude value.

Further, as an aptitude degree of each recommendation algorithm, the algorithm determination unit 16 may use an appreciation degree having been acquired from the appreciation degree acquisition unit 14 just as it is.

Further, a user tends to appreciate an appreciation item the user values. Therefore, the algorithm determination unit 16 may determine an appreciation item having the largest number of times for appreciation as an item valued by the user. In this case, in the example shown in FIG. 13, the algorithm determination unit 16 may determine that the user values the “unpredictability degree” having the largest number of times for appreciation. Further, the algorithm determination unit 16 may determine the algorithm C having the highest unpredictability-degree value as a recommendation algorithm having the highest aptitude value.

As described above, according to the first exemplary embodiment, the list creation unit 13 of the algorithm determination device 10 produces, to a user, a content list including recommendation orders having been calculated by a recommendation algorithm which is regarded as an optimal recommendation algorithm. The appreciation degree acquisition unit 14 acquires an appreciation degree for the content list from the user. The importance degree calculation unit 15 calculates an importance degree for the content having been selected by the user, according to each of the recommendation algorithms. The algorithm determination unit 16 calculates aptitude values of the respective algorithms based on the appreciation degree having been acquired by the appreciation degree acquisition unit 14 and the importance degrees having been calculated by the importance degree calculation unit 15, and further, stores the calculated results into the aptitude value storage unit 19. By employing such a configuration as described above, the algorithm determination device 10 can reflect a user's appreciation on a recommendation result. As a result, the algorithm determination device 10 can bring about the advantageous effect of enabling produce of an optimal recommendation result for a user.

In addition, in the first exemplary embodiment, description has been made by an example in which the individual functions are realized by software program executed by the CPU. Nevertheless, when realizing the recommendation assist system according to the first exemplary embodiment, the individual functions shown in FIG. 1 can be recognized as given function units each of which can be realized by at least one of a software program and hardware. Accordingly, part of or the whole of the individual functions may be realized as hardware.

Further, in each of the devices constituting this recommendation assist system, the computer program should be stored in the storage device (storage medium) 51, such as readable and writable memory modules or a hard disk device. Moreover, in such a case, the present invention is configured as codes of a computer program or a storage medium therefore.

### Second Exemplary Embodiment

FIG. 14 is a block diagram illustrating a configuration of a recommendation assist device 60 according to a second exemplary embodiment of the present invention. As shown in FIG. 14, the recommendation assist device 60 includes an appreciation degree acquisition unit (an appreciation degree acquisition means) 61 and an algorithm determination unit (an algorithm determination means) 62.

The appreciation degree acquisition unit 61 acquires a user's appreciation degree from the user on an algorithm which is one of algorithms each for calculating recommendation orders of a respective plurality of contents, and which has calculated recommendation orders of respective contents thereof having been produced to the user. The algorithm determination unit 62 calculates aptitude values of the respective plurality of algorithms based on the acquired appreciation degree. The appreciation degree acquisition unit 61 corresponds to the appreciation degree acquisition unit 14 according to the first exemplary embodiment. The algorithm determination unit 62 corresponds to the algorithm determination unit 16 according to the first exemplary embodiment.

In this way, according to the second exemplary embodiment, as described above, the recommendation assist device 60 can bring about aptitude degrees of the respective algorithms, which have reflected a user's appreciation, and which are more useful for the user, just like in the case of the first exemplary embodiment. As a result, the recommendation assist device 60 can produce a further useful recommendation result for a user.

Hereinbefore, the present invention has been described with reference to the aforementioned exemplary embodiments, but is not limited to the aforementioned exemplary embodiments. Various changes which can be understood by those skilled in art can be made on the configuration and the details of the present invention within the scope not departing from the gist of the present invention.

In addition, this application is based upon and claims the benefit of priority from Japanese Patent Application No. 2010-185969 filed on Aug. 23, 2010, the disclosure of which is incorporated herein in its entirety by reference.

Part of or the whole of the aforementioned exemplary embodiments can be described in such a way as those of the following supplementary notes, but is not limited to the following supplementary notes.

### (Supplementary Note 1)

A recommendation assist device including:

appreciation degree acquisition means for acquiring a user's appreciation degree on a certain algorithm which is one of a plurality of algorithms each for calculating recommendation orders of respective contents, and which has calculated recommendation orders of the respective contents having been provided to the user; and

algorithm determination means for calculating aptitude degrees of the respective plurality of algorithms based on the acquired appreciation degree.

### (Supplementary Note 2)

The recommendation assist device according to supplementary note 1, further including:

importance degree calculation means for calculating, for the respective plurality of algorithms, importance degrees of a certain content having been selected by the user,

wherein the algorithm determination means calculates aptitude degrees of the respective plurality of algorithms based on the calculated importance degrees and the acquired appreciation degree.

### (Supplementary Note 3)

The recommendation assist device according to supplementary note 2, wherein the importance degree calculation means calculates reciprocals of the recommendation orders of the certain content, which have been calculated by the respective plurality of algorithms, as importance degrees of the certain content.

### (Supplementary Note 4)

The recommendation assist device according to supplementary note 2 or supplementary note 3, wherein the algorithm determination means predicts aptitude degrees of respective algorithms which are included in the plurality of algorithms, and for which the user's appreciation degrees are not acquired, based on the aptitude degree of the certain algorithm for which the user's appreciation degree has been acquired, and the importance degrees having been calculated by the importance degree calculation means.

### (Supplementary Note 5)

The recommendation assist device according to any one of supplementary notes 1 to 4, wherein, after the certain content has been selected by the user, the appreciation degree acquisition means acquires the user's appreciation degree.

### (Supplementary Note 6)

The recommendation assist device according to any one of supplementary notes 1 to 5, wherein the appreciation degree acquisition means acquires a user's satisfaction degree as the appreciation degree.

### (Supplementary Note 7)

A user device including:

means for receiving a user's appreciation degree on recommendation orders of respective contents having been produced by the recommendation assist device according to any one of supplementary notes 1 to 6; and

means for transmitting the received appreciation degree to the recommendation assist device.

### (Supplementary Note 8)

A recommendation assist system including:

the recommendation assist device according to any one of supplementary notes 1 to 6; and

the user device according to supplementary note 7.

### (Supplementary Note 9)

A recommendation assist method including:

acquiring a user's appreciation degree on a certain algorithm which is one of a plurality of algorithms each for calculating recommendation orders of respective contents, and which has calculated recommendation orders of the respective contents having been produced to the user; and

calculating aptitude degrees of the respective plurality of algorithms based on the acquired appreciation degree.

### (Supplementary Note 10)

The recommendation assist method according to supplementary note 9, further including:

for the respective plurality of algorithms, calculating importance degrees of a certain content having been selected by the user,

wherein, when calculating aptitude degrees of the respective plurality of algorithms, the aptitude degrees of the respective plurality of algorithms are calculated based on the calculated importance degrees and the acquired appreciation degree.

### (Supplementary Note 11)

The recommendation assist method according to supplementary note 10, wherein, when calculating importance degrees of the respective plurality of algorithms, reciprocals of the recommendation orders of the certain content, which having been calculated by the respective plurality of algorithms, are determined as the importance degrees of the certain content.

### (Supplementary Note 12)

The recommendation assist method according to supplementary note 10 or supplementary note 11, wherein, when calculating aptitude degrees of the respective plurality of algorithms, aptitude degrees of respective algorithms which are included in the plurality of algorithms, and for which the user's appreciation degrees are not acquired, are predicted based on the aptitude degree of the certain algorithm for which the user's appreciation degree has been acquired, and the calculated importance degrees.

### (Supplementary Note 13)

The recommendation assist method according to any one of supplementary notes 9 to 12, wherein acquiring the user's appreciation degree after the certain content has been selected by the user,

### (Supplementary Note 14)

The recommendation assist method according to any one of supplementary notes 9 to 13, wherein a user's satisfaction degree is acquired as the appreciation degree.

### (Supplementary Note 15)

A program storage medium which stores therein a program causing a computer to execute processing including:

a process of acquiring a user's appreciation degree on a certain algorithm which is one of a plurality of algorithms each for calculating recommendation orders of respective contents, and which has calculated recommendation orders of the respective contents having been produced to the user; and

a process of calculating aptitude degrees of the respective plurality of algorithms based on the acquired appreciation degree.

### (Supplementary Note 16)

The program storage medium according to supplementary note 15, which stores therein a program causing a computer to execute processing further including:

a process of, for the respective plurality of algorithms, calculating importance degrees of a certain content having been selected by the user,

wherein, when calculating aptitude degrees of the respective plurality of algorithms, the aptitude degrees of the respective plurality of algorithms are calculated based on the calculated importance degrees and the acquired appreciation degree.

### (Supplementary Note 17)

The program storage medium according to supplementary note 15 or supplementary note 16, wherein, when calculating importance degrees of the respective plurality of algorithms, reciprocals of the recommendation orders of the certain content, which having been calculated by the respective plurality of algorithms, are determined as the importance degrees of the certain content.

### (Supplementary Note 18)

The program storage medium according to supplementary note 16 or supplementary note 17, wherein, when calculating aptitude degrees of the respective plurality of algorithms, aptitude degrees of respective algorithms which are included in the plurality of algorithms, and for which the user's appreciation degrees are not acquired, are predicted based on the aptitude degree of the certain algorithm for which the user's appreciation degree has been acquired, and the calculated importance degrees.

### (Supplementary Note 19)

The program storage medium according to any one of supplementary notes 15 to 18, wherein the program includes a program causing the computer to execute a processing including a process of acquiring the user's appreciation degree after the certain content has been selected by the user.

### (Supplementary Note 20)

The program storage medium according to any one of supplementary notes 15 to 19, wherein a user's satisfaction degree is acquired as the appreciation degree.

### INDUSTRIAL APPLICABILITY

The present invention can be applied to, for example, a searching system for providing various pieces of information.

### REFERENCE SIGNS LIST

10 Algorithm determination device
11 Communication unit
12 Control unit
13 List creation unit
14 Appreciation degree acquisition unit
15 Importance degree calculation unit
16 Algorithm determination unit
17 Appreciation degree storage unit
18 Algorithm storage unit
19 Aptitude value storage unit
30 User device
31 Communication unit
32 Input unit
33 Display unit
50 CPU
51 Storage medium
52 Program
60 Recommendation assist device
61 Appreciation degree acquisition unit
62 Algorithm determination unit
100 Recommendation assist system
200 The internet
201 Server

1.-10. (canceled)

11. A recommendation assist device comprising:
an appreciation degree acquisition unit to acquire a user's appreciation degree on a certain algorithm which is one of a plurality of algorithms each for calculating recommendation orders of respective contents, and which has calculated recommendation orders of the respective contents having been provided to the user; and
an algorithm determination unit to calculate aptitude degrees of the respective plurality of algorithms based on the acquired appreciation degree.

12. The recommendation assist device according to claim 11, further comprising:
an importance degree calculation unit to calculate, for the respective plurality of algorithms, importance degrees of a certain content having been selected by the user,
wherein the algorithm determination unit calculates aptitude degrees of the respective plurality of algorithms based on the calculated importance degrees and the acquired appreciation degree.

13. The recommendation assist device according to claim 12, wherein
the importance degree calculation unit calculates reciprocals of the recommendation orders of the certain content, which have been calculated by the respective plurality of algorithms, as importance degrees of the certain content.

14. The recommendation assist device according to claim 12, wherein
the algorithm determination unit predicts aptitude degrees of respective algorithms which are included in the plurality of algorithms, and for which the user's appreciation degrees are not acquired, based on the aptitude degree of the certain algorithm for which the user's appreciation degree has been acquired, and the importance degrees having been calculated by the importance degree calculation unit.

15. The recommendation assist device according to claim 11, wherein, after the certain content has been selected by the user, the appreciation degree acquisition unit acquires the user's appreciation degree.

16. The recommendation assist device according to claim 11, wherein the appreciation degree acquisition unit acquires a user's satisfaction degree as the appreciation degree.

17. A user device comprising:
a unit to receive a user's appreciation degree on recommendation orders of respective contents having been produced by the recommendation assist device according to claim 11; and
a unit to transmit the received appreciation degree to the recommendation assist device.

18. A recommendation assist system comprising:
a recommendation assist device and a user device,
wherein the recommendation assist device includes:
an appreciation degree acquisition unit to acquire a user's appreciation degree on a certain algorithm which is one of a plurality of algorithms each for calculating recommendation orders of respective contents, and which has calculated recommendation orders of the respective contents having been provided to the user, and
an algorithm determination unit to calculate aptitude degrees of the respective plurality of algorithms based on the acquired appreciation degree,
wherein the user device includes:
a unit to receive a user's appreciation degree on recommendation orders of respective contents having been produced by the recommendation assist device, and
a unit to transmit the received appreciation degree to the recommendation assist device.

19. A recommendation assist method comprising:
acquiring a user's appreciation degree on a certain algorithm which is one of a plurality of algorithms each for calculating recommendation orders of respective contents, and which has calculated recommendation orders of the respective contents having been produced to the user; and
calculating aptitude degrees of the respective plurality of algorithms based on the acquired appreciation degree.

20. The recommendation assist method according to claim 19, further comprising:
for the respective plurality of algorithms, calculating importance degrees of a certain content having been selected by the user,
wherein, when calculating aptitude degrees of the respective plurality of algorithms, the aptitude degrees of the respective plurality of algorithms are calculated based on the calculated importance degrees and the acquired appreciation degree.

21. The recommendation assist method according to claim 20, wherein, when calculating importance degrees of the respective plurality of algorithms, reciprocals of the recommendation orders of the certain content, which having been calculated by the respective plurality of algorithms, are determined as the importance degrees of the certain content.

22. The recommendation assist method according to claim 20, wherein, when calculating aptitude degrees of the respective plurality of algorithms, aptitude degrees of respective algorithms which are included in the plurality of algorithms, and for which the user's appreciation degrees are not acquired, are predicted based on the aptitude degree of the certain algorithm for which the user's appreciation degree has been acquired, and the calculated importance degrees.

23. The recommendation assist method according to claim 19, wherein acquiring the user's appreciation degree after the certain content has been selected by the user.

24. The recommendation assist method according to claim 19, wherein a user's satisfaction degree is acquired as the appreciation degree.

25. A non-transitory program storage medium which stores therein a program causing a computer to execute processing comprising:
a process of acquiring a user's appreciation degree on a certain algorithm which is one of a plurality of algorithms each for calculating recommendation orders of respective contents, and which has calculated recommendation orders of the respective contents having been produced to the user; and
a process of calculating aptitude degrees of the respective plurality of algorithms based on the acquired appreciation degree.

26. The non-transitory program storage medium according to claim 25, which stores therein a program causing a computer to execute processing further comprising:
a process of, for the respective plurality of algorithms, calculating importance degrees of a certain content having been selected by the user,
wherein, when calculating aptitude degrees of the respective plurality of algorithms, the aptitude degrees of the respective plurality of algorithms are calculated based on the calculated importance degrees and the acquired appreciation degree.

27. The non-transitory program storage medium according to claim 25, wherein, when calculating importance degrees of the respective plurality of algorithms, reciprocals of the recommendation orders of the certain content, which having been calculated by the respective plurality of algorithms, are determined as the importance degrees of the certain content.

28. The non-transitory program storage medium according to claim 26, wherein, when calculating aptitude degrees of the respective plurality of algorithms, aptitude degrees of respective algorithms which are included in the plurality of algorithms, and for which the user's appreciation degrees are not acquired, are predicted based on the aptitude degree of the certain algorithm for which the user's appreciation degree has been acquired, and the calculated importance degrees.

29. The non-transitory program storage medium according to claim 25, wherein the program includes a program causing the computer to execute a processing including a process of acquiring the user's appreciation degree after the certain content has been selected by the user.

30. The non-transitory program storage medium according to claim 25, wherein a user's satisfaction degree is acquired as the appreciation degree.
